(19) United States
(12) Patent Application Publication
(10) Pub. No.: US 2024/0281622 A1
(43) Pub. Date: Aug. 22, 2024

(54) Method and System to Provide Content Performance Score

(71) Applicant: Dell Products L.P., Round Rock, TX (US)

(72) Inventors: Angela Diggin, Dublin (IE); Anja Holler, Lorrach (DE); Julie Feytout, Gardonne (FR); Wei Ge, Beijing (CN); Rupashree Kalita, Bangalore (IN)

(73) Assignee: Dell Products L.P., Round Rock, TX (US)

(21) Appl. No.: 18/110,496

(22) Filed: Feb. 16, 2023

(51) Int. Cl. G06F 40/58; G06F 40/279; G06F 40/51

(52) U.S. Cl. CPC G06F 40/58; G06F 40/279; G06F 40/51

(57) ABSTRACT

Described herein are methods and a system for determining performance and providing a content score of translated content from an original source document or content. Quality and fitness of the original source content is checked, and translatability profile and natural language processing (NLP) profile is provided. The translatability profile and natural language processing (NLP) profile are used to provide a level of machine translation level to be performed on the original source document. The original source document or content is translated into a different language. The translated content is checked for quality, which is used along with user experience (UX) of the translated content to provide a content score of the translated content.

### BACKGROUND OF THE INVENTION

### Field of the Invention

The present invention relates to translated content supporting devices and services. More specifically, embodiments of the invention provide for determining performance and content scoring of translated content.

### Description of the Related Art

Documents, such as manuals, service bulletins, etc., are provided to customers of devices and/or services. Such documents can be language specific content. The language specific content can be translated to other languages to support customers of the same devices and/or services. For example, an original English document supporting a particular device is translated to Japanese, French, German, Chinese specific documents supporting the particular device.

The translation of the original document/content can be performed using machine translation and/or human translation. Machine translation can be more efficient and less costly than human translation; however, machine translation can lead to mistakes or errors that would not occur with human translation. Determining when a document is machine translated, human translated, or a combination of both, can be very subjective. Mistakes or errors in translation can lead to poor customer satisfaction or frustration as to the translated documents/content. Therefore, it is desirable to provide translated documents/content with the least number of mistakes, translated efficiently and cost effectively.

Typically, multilingual translated content is evaluated based on linguistic qualities. No consideration is taken as to how the translated content is consumed or used by customers. Furthermore, return on investment (ROI) or cost benefit of how content is translated (e.g., machine translated, human translated, or combination) is not considered. Determining performance and effectiveness of translated content over a life cycle would be beneficial in providing better documents for products and services for customers of different languages.

### SUMMARY OF THE INVENTION

A computer-implementable method, system and computer-readable storage medium for determining performance and content scoring of translated content comprising translating an original source content of a particular language to the translated content in another language; checking the original source content as to quality to provide a translatability profile and natural language processing (NLP) profile; determining machine translation level to be performed on the original source content based on the translatability profile and NLP profile; checking the translated content as to quality; determining a content performance score of the translated content based on the quality of the translated content and user experience (UX) of the translated content.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a system as implemented in the present invention;

FIG. 2 illustrates a content performance assessment cycle;

FIG. 3 illustrates a workflow to determine content performance scores;

FIG. 4 illustrates a flowchart for data flow for content performance scores;

FIG. 5 illustrates data mapping of quality performance;

FIG. 6 illustrates a flowchart for determining performance and content scoring of translated content; and

FIG. 7 is a general illustration of components of an information handling system as implemented in the present invention.

### DETAILED DESCRIPTION

Described herein are systems and processes that provide for a model to predict readiness for machine translation (MT) of original source document or content. The original source document or content can be English language and is translated to other languages. Implementations provide for a translatability profile and natural language processing (NLP) profile framework implementing artificial intelligence (AI)/machine learning (ML) derived profiles to detect terminology and queries to categorize source document or content performance. The categorizing can be associated with different levels of MT output. The highest category or level can include elements of the AI/ML that lowers manual (human) interactions and efforts to lower costs of translation. The NLP profile is an NLP based algorithm as to content domain, unknown terminology and translation queries in the original source document or content.

The model addresses measuring linguistics as part of a process with no particular connection to the source document or content. Translation is considered as a larger ecosystem, measuring various inputs, source document or content, derivatives (i.e., translated content), as translation progresses. This can create and provide a holistic view of performance of translated documents or content, leading to more effective and cost efficient translation.

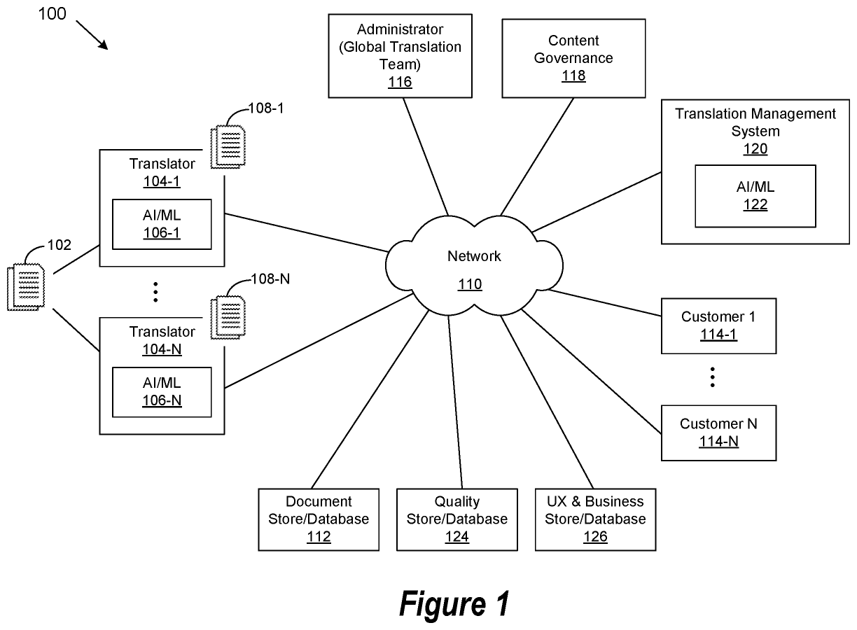

FIG. 1 shows a system 100 that supports the processes described herein. A source document (content) 102 can be a document supporting devices or services (i.e., products) and is written in a particular language, such as English. The source document 102 is provided to one or more translators 104. Translators 104 can be embodied as information handling systems as further described herein, cloud computing, etc.

Implementations provide for the translators to support human translators (HT) and/or machine translators (MT). The translators 104 can include artificial intelligence (AI)/machine learning (ML) (AI/ML) components 106 used in translating the source document 102 to different languages.

A language specific document 108 is provided by the translators 104. For example, language specific documents 108 can include French, German, Hindi, Chinese, Japanese, etc. language specific documents 108.

In various implementations, the translators 104 and other elements of the system 100 are connected to and communicate with one another through a network 110. The network 110 can include one or more wired and wireless networks, including the Internet.

In various implementations, the translators 104 send/store their respective language specific documents 108 to a document store/database 112. The language specific documents 108 can be used/consumed by various language specific customers 114.

In various implementations, the translators 104 and the services they provide are overseen by an administrator element 116. Administrator 116 can be embodied as information handling systems as further described herein, cloud computing, etc. Administrator 116 can be accessed/used by a global translation team responsible for oversight of translation from translator 104, including language related services (e.g., translation, consulting, interpretation, etc.).

Implementations provide for the system 100 to include a content governance element 118 that can provide content governance tools, such as software to assess the quality and fitness of content (e.g., spelling, grammar, style, terminology, etc.).

The system can further include a translation management system 120. The translation management system 120 can include an AI/ML component 122. The translation management system 120 and AI/ML component 122 are further described herein.

Various implementations further provide for the system to include a quality store/database 124 and a UX & business store/database 126 which are further described herein.

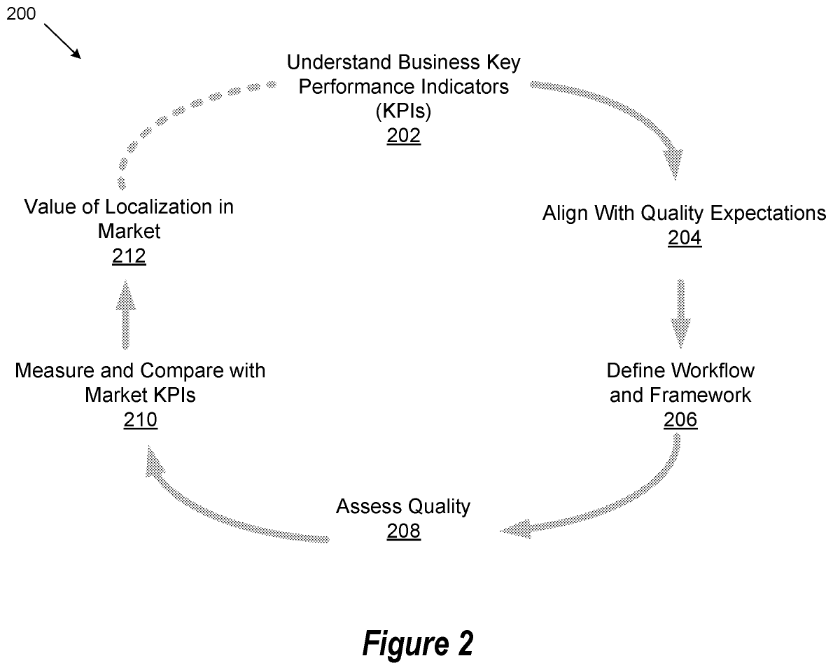

FIG. 2 shows content performance assessment cycle 200. Stages in cycle 200 are used in determining a content performance score as described herein. The stages include data streams, where the cycle 200 aligns such data streams. In various implementations, the cycle 200 begins with understanding key business performance indicators (KPI) related to translated documents 202.

KPIs can also include business indicator KPIs. Examples of business indicator KPIs include the following. Sales showing new sales, length of sales cycle, conversion rate, etc. Marketing that includes page (i.e., web page) view click through rates, time on page, conversions, social media shares, etc. Product documentation that includes number of releases, user satisfaction, user ratings (e.g., accuracy, usefulness, easy to understand, issues solved), etc. Software including chum rate, customer retention rate, customer acquisition cost and lifetime value, recurring revenue, etc. Multimedia and events/interpreting that includes event check-in, surveys, active community members, speaker engagement, attendees/views, etc.

The cycle 200 further includes aligning with quality expectations 204, defining content translation workflow and framework 206, assessing quality of translated content 208, measuring and comparing translated content as to market KPIs 210, and determining value of translated content in localized markets 212. The cycle 200 can be an iterative process.

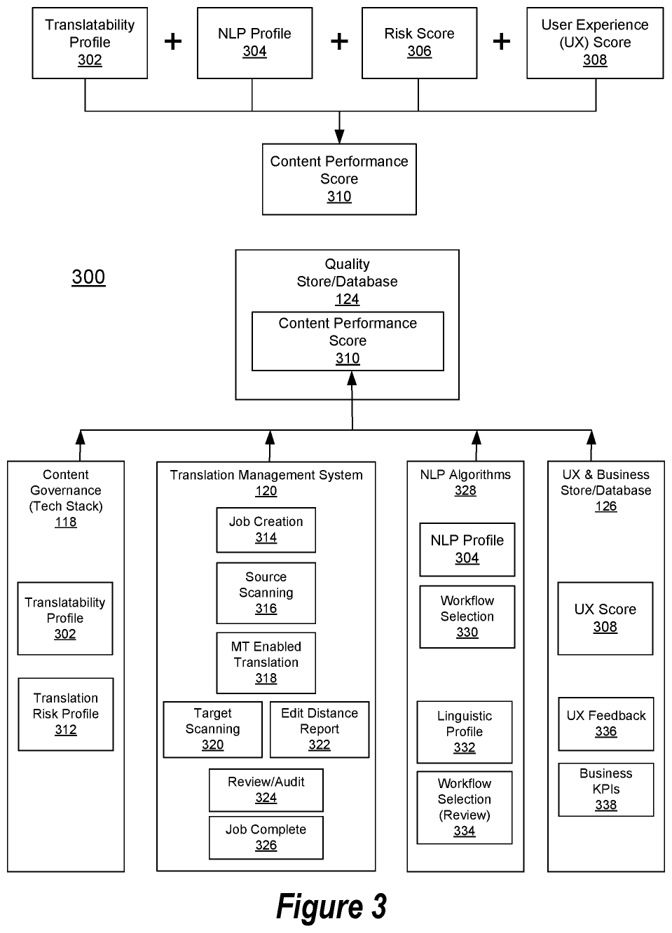

FIG. 3 shows a workflow 300 to determine content performance scores. By assessing each stage of cycle 200, content performance scores for translated content can be determined. An aggregation of a translatability profile 302, a natural language processing (NLP) profile 304, a risk assessment score or risk score 306, and user experience scores 308 is used to derive a content performance score 310.

Translatability profile 302 is directed to translatability of the original source document. In various implementations, the content governance 118 shown in FIG. 1 determines source quality and domain.

The NLP profile 304 provides source analytics to predict queries, extract terminology, and drive workflows. The AI/ML components 106 of translators 104 can be used to provide NLP profiles. Translatability profile 302 and NLP profile 304 allows the ability to create an NLP predictable workflow model which can reduce manual (human) interaction from file management activities in the translation process.

The risk scores 306 are used to monitor and predict target performance that drives workflows (i.e., content translation). A risk algorithm is used to determine risk scores. The risk algorithm computes job level linguistic quality scores into a comprehensive and customized risk score. The risk algorithm can consider distinct criteria such as number of penalty points per thousand words, average score quality, dispersion of results, number of scorecards, pass ratio, etc. With a risk score, a determination can be made as to not reviewing translation output (i.e., forgoing costly human review). Otherwise, evaluation during review of performance of translation output may be performed.

User experience (UX) scores 308 are based on how end user customers of the translated content are consuming the translated content. The UX scores can be collected from customers 114 and stored in UX & business store/database 126. UX scores can include customer satisfaction (CSAT) score, or CSAT scores which are customer experience metrics measuring happiness with translated documents/content. Implementations provide for evaluation of business KPIs versus quality expectations and measuring against target content user experiences.

Implementations provide for content performance scores 310 to be stored in quality store/database 124 shown in FIG. 1. Various sources can provide data in deriving the content performance score 310. A source includes the content governance 118. Data flows from and to the content governance 118 and the quality store/database 124. In certain implementations, a tech stack of the content governance 118 provides a translatability profile 302 and translation risk profile 312. The translatability profile 302 is provided to the content performance score 310 as described herein.

The translation management system 120 provides and receives data with other sources used to derive the content performance score 310. In certain implementations, the translation management system 120 includes an AI/ML enabled job creation component 314, which is part of a workflow to source scanning component 316. The source scanning component 316 provides information to the translatability profile 302.

The translation management system 120 can include an AI/ML enabled machine translation (MT) enabled translation component 318, which is part of workflow to a target scanning component 320 and to an AI/ML enabled edit distance report component 322. The target scanning component 320 is AI/ML enabled to assess target quality. Implementations can include AI, as well as NLP rules and quality assurance (QA) rules in order to assess risk in translation. For example, a relatively high risk tends to go to review (human review) and low risk can be delivered as is (i.e., machine translated). Edit distance goes to measuring changes between two versions of a translation. For example, counting the number of characters that are added, deleted, and substituted. The AI/ML enabled edit distance report component 322 supports edit distance and provides a report and receives/sends data to the quality store/database 124.

Implementations further provide for the translation management system 120 include AI/ML enabled review/audit component 324 and job complete component 326. The review/audit component 324 is part of a workflow to the job complete component 326.

A source providing data to the content performance score 310 is NLP algorithms 328. As discussed, the NLP profile 304 is provided to content performance score 310 and is included in NLP algorithms 328. The NLP profile 304, which receives information from source scanning 316. The NLP profile 304 is part of a workflow to a workflow selection component 330. The workflow selection component 330 receives information from the translatability profile 302. The workflow selection component 330 is part of a workflow to MT enabled translation component 318.

Implementations further provide for NLP algorithms 328 to include a linguistics profile component 332. The linguistics profile component 332 receives information from translation risk profile 312, target scanning 320, and edit distance report 322. The linguistics profile component 332 receives and sends data to quality store/database 124.

The linguistics profile component 332 is part of a workflow to a workflow selection (review) component 334. The workflow selection (review) component 334 provides information to the review/audit component 324 and job complete component 326.

The UX & business store/database 126 is a source that provides the UX score 308 to the content performance score 310. UX & business store/database 126 can include data such as UX feedback 336 and business feedback 338. Implementations include the data of UX feedback 336 and business feedback 338 to be processed by AI/ML steps performed at the translation management system 120. Information from UX feedback 336 and business feedback 338 can be provided to the UX score 308.

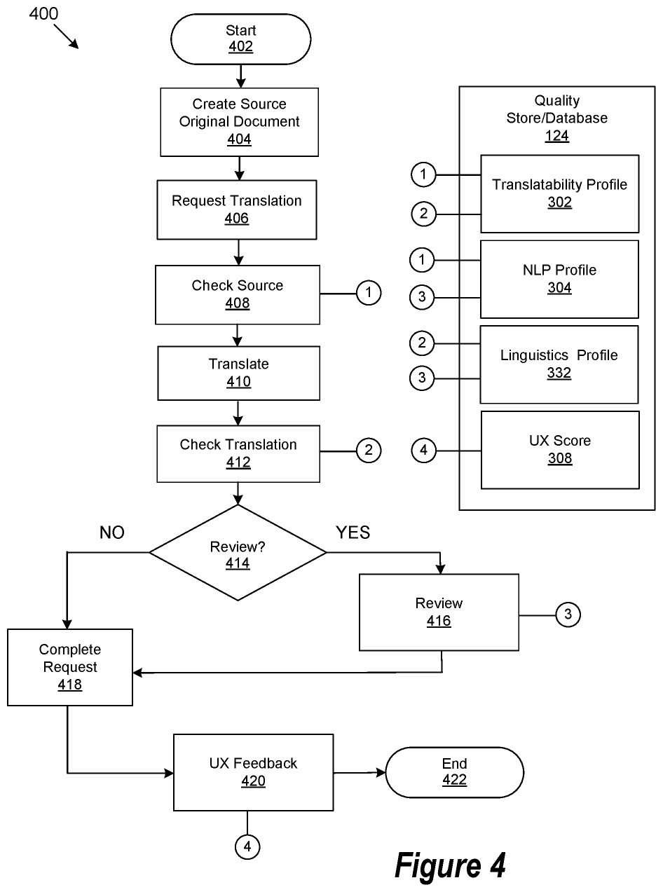

FIG. 4 shows a generalized flowchart for data flow for content performance scores. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 402, the process 400 begins. At step 404, an original source document is created. The original source document or content is created based on a particular language, such as English. There can be an original owner of the source document. The source document can be received and stored from various stores/databases, including document/store 112.

At step 406, a request for translation to another language is performed. The request can be from various sources including a global translation team through administrator 116. In various implementations, the translation management system 120 can be used to perform the request.

At step 408, the source document is checked. This can include checking for quality and fitness of content (e.g., spelling, grammar, style, terminology, etc.). This step can be performed through an AI/ML learning process implemented by the translation management system 120 (i.e., AI/ML component 122). The results can be stored in quality store/database 124, and used by translatability profile 302 and NLP profile 304.

At step 410, translation is performed. The translation as described herein can be performed by the translators 104, and producing language specific documents 108.

At step 412, the translated language specific document 108 is checked for quality and fitness of content (e.g., spelling, grammar, style, terminology, etc.). This step can be performed through an AI/ML learning process implemented by the translation management system 120 (i.e., AI/ML component 122). The results can be stored in quality store/database 124, and used by NLP profile 304 and linguistics profile 332.

At step 414, a decision is made whether to review the quality of the translated language specific document 108. If a review is to be performed, following the YES branch of step 414, at step 416 a review is performed. The results can be stored in quality store/database 124, and used by translatability profile 302 and linguistics profile 332. At step 418, the request for translation is considered complete.

If no review is to be performed, following the NO branch of step 414, at step 418, the request for translation is considered complete. At step 420, user experience (UX) feedback is received. The UX feedback can be from the marketplace of customers (i.e., consumers of document 108). The results can be stored in quality store/database 124, and used by linguistics profile 332 and UX score 308. At step 422, the process 400 ends.

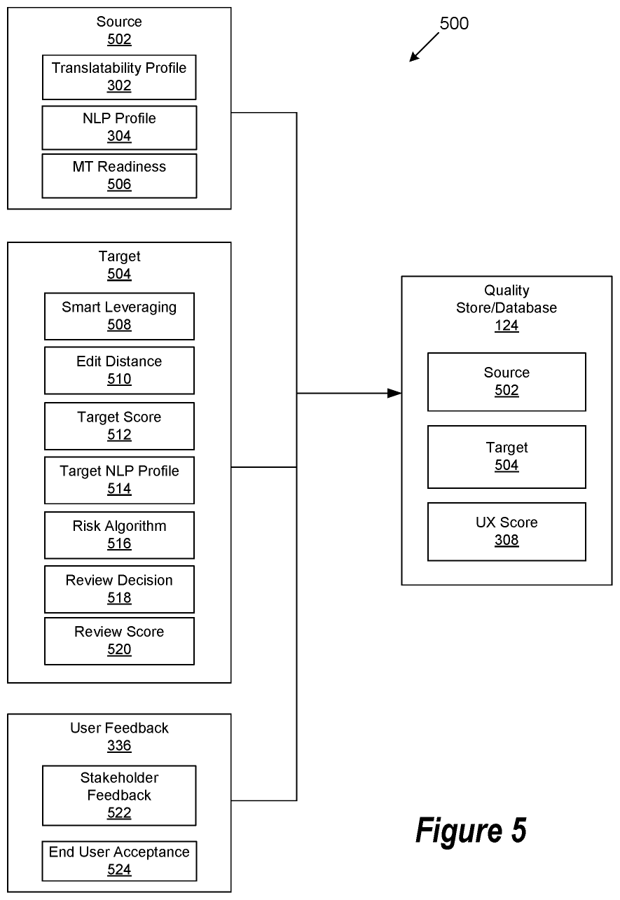

FIG. 5 shows data mapping 500 of quality performance. The data mapping 500 provides a source document profile 502 and target document profile 504. The source document profile 502 relates to the original language document and the target document profile 504 relates to the translated document/content.

The source document profile 502 includes translatability profile 302, NLP profile 304, and an MT readiness profile 506. The source document profile 502 can be stored in the quality store/database 124.

Implementations provide for the target document profile 504 to include a smart leveraging profile 508. Smart leveraging is directed to scanning a segment of a target document before the target document is used. The segment can be scanned using AI, NLP, and/or QA rules. The scanned segment can be discarded, promoted or demoted depending on the result. For example, if the scan detects that the translation for a specific term does not match the approved terminology, the segment will be marked for special attention. If the segment was previously reviewed, the segment can get promoted over other possible matches.

Furthermore, implementations provide for the target document profile 504 to include an edit distance profile 510, a target score profile 512, a target NLP profile 514, risk algorithm 516, review decision 518, and a review score 520.

Data mapping 500 also can include user feedback 336. User feedback 336 can include a stakeholder feedback 522 and end user acceptance 524. The source document profile 502, target document profile 504, and user feedback 336 can be stored in quality store/database 124.

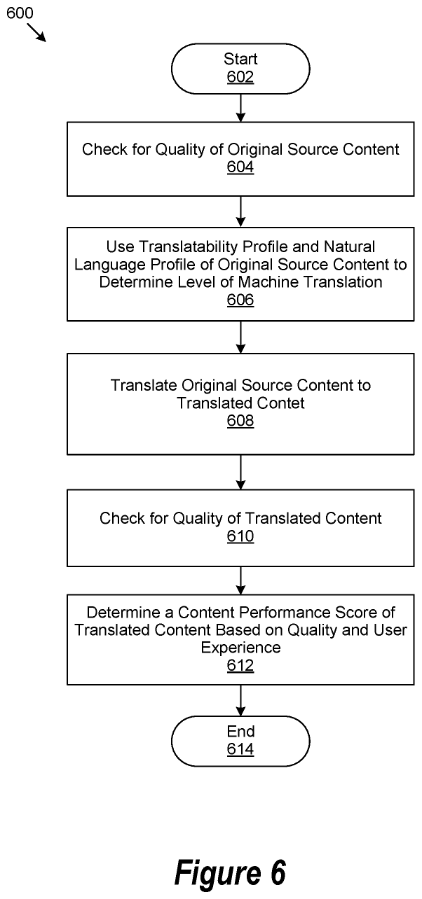

FIG. 6 shows a generalized flowchart for determining performance and content scoring of translated content. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 602, the process 600 starts. At step 604, the quality is checked of an original source document or content. The checking includes quality and fitness of the original source document or content, such as spelling, grammar, style, terminology, etc. Translatability profile 302 and NLP profile 304 can be determined from the checking.

At step 606, using the translatability profile 302 and NLP profile 304, a determination is made as to the level of machine translation to be performed on the original source document or content.

At step 608, the original source document or content in a particular language, such as English, is translated to translated document or content in another language. The translation can be performed by translators 104. The original source document or content being the source document 102 and the translated document or content being language specific document 108.

At step 610, quality is checked of the translated document or content. The checking includes quality and fitness of the translated document or content, such as spelling, grammar, style, terminology, etc.

At step 612, a content performance score of the translated document or content or language specific document 108 is determined based on the quality of the translated document or content and user experience of the translated document or content. At step 614, the process 600 ends.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

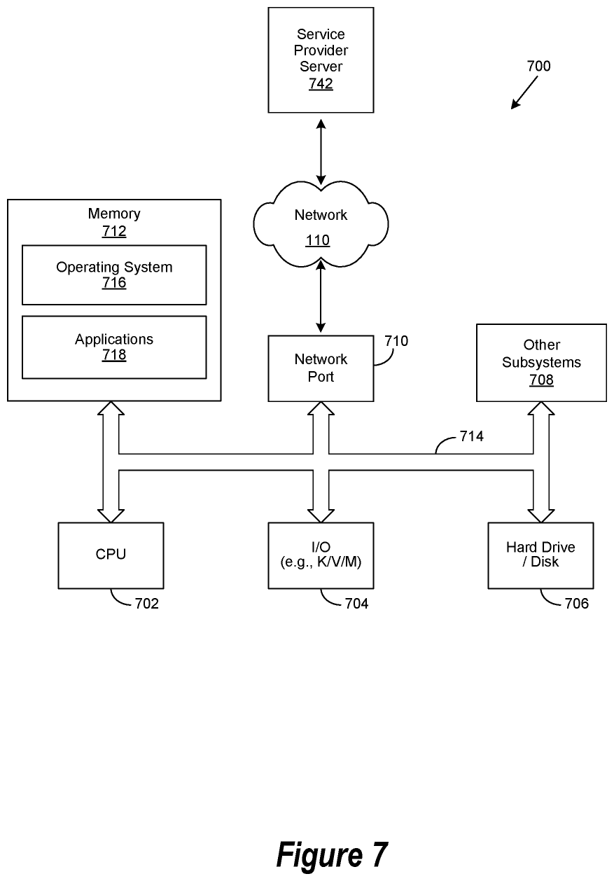

FIG. 7 is a generalized illustration of an information handling system 700 that can be used to implement the system and method of the present invention. The information handing system 700 can be a host to the peripheral devices described herein.

The information handling system 700 includes a processor (e.g., central processor unit or “CPU”) 702, input/output (I/O) devices 704, such as a microphone, a keyboard, a video display or display device, a mouse, and associated controllers (e.g., K/V/M), a hard drive or disk storage 706, and various other subsystems 708.

In various embodiments, the information handling system 100 also includes network port 710 operable to connect to the described network 110. As described, network 110 can include one or more wired and wireless networks, including the Internet. Network 110 is likewise accessible by a service provider server 742.

The information handling system 700 likewise includes system memory 712, which is interconnected to the foregoing via one or more buses 714. System memory 712 can be implemented as hardware, firmware, software, or a combination of such. System memory 712 further includes an operating system (OS) 716 and applications 718. Implementations provide for applications 718 to include management software 720 that allows the information handling system 700 to access devices, such as devices residing at remote data centers. Access can be through web based user interfaces.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for determining performance and content scoring of translated content comprising:
checking an original source content of a particular language as to quality to provide a translatability profile and natural language processing (NLP) profile;
determining machine translation level to be performed on the original source content based on the translatability profile and NLP profile;
translating the original source content of the particular language to the translated content in another language;
checking the translated content as to quality;
determining a content performance score of the translated content based on the quality of the translated content and user experience (UX) of the translated content.

2. The computer-implementable method of claim 1, wherein the translatability profile and the natural language processing (NLP) profile are used to detect terminology and queries to categorize source content performance.

3. The computer-implementable method of claim 1, wherein the NLP profile provides source analytics to predict queries, extract terminology, and drive workflows.

4. The computer-implementable method of claim 1, wherein source scanning component provides information to the translatability profile and the NLP profile.

5. The computer-implementable method of claim 1, wherein the machine translation level accounts for a risk profile.

6. The computer-implementable method of claim 1, wherein checking the translated content as to quality includes spelling, grammar, style, and/or terminology.

7. The computer-implementable method of claim 1 further comprising use of a risk score and user experience score with the translatability profile and NLP profile to determine the content performance score.

8. A system comprising:
a plurality of processing systems communicably coupled through a network, wherein the processing systems include non-transitory, computer-readable storage medium embodying computer program code interacting with a plurality of computer operations for determining performance and content scoring of translated content comprising:
checking an original source content of a particular language as to quality to provide a translatability profile and natural language processing (NLP) profile;
determining machine translation level to be performed on the original source content based on the translatability profile and NLP profile;
translating the original source content of the particular language to the translated content in another language;
checking the translated content as to quality;
determining a content performance score of the translated content based on the quality of the translated content and user experience (UX) of the translated content.

9. The system of claim 8, wherein the translatability profile and the natural language processing (NLP) profile are used to detect terminology and queries to categorize source content performance.

10. The system of claim 8, wherein the NLP profile provides source analytics to predict queries, extract terminology, and drive workflows.

11. The system of claim 8, wherein source scanning component provides information to the translatability profile and the NLP profile.

12. The system of claim 8, wherein the machine translation level accounts for a risk profile.

13. The system of claim 8, wherein checking the translated content as to quality includes spelling, grammar, style, and/or terminology.

14. The system of claim 8 further comprising use of a risk score and user experience score with the translatability profile and NLP profile to determine the content performance score.

15. A non-transitory, computer-readable storage medium embodying computer program code, the computer program code comprising computer executable instructions configured for determining performance and content scoring of translated content:
checking an original source content of a particular language as to quality to provide a translatability profile and natural language processing (NLP) profile;
determining machine translation level to be performed on the original source content based on the translatability profile and NLP profile;
translating the original source content of the particular language to the translated content in another language;
checking the translated content as to quality;
determining a content performance score of the translated content based on the quality of the translated content and user experience (UX) of the translated content.

16. The non-transitory, computer-readable storage medium of claim 15, wherein the translatability profile and the natural language processing (NLP) profile are used to detect terminology and queries to categorize source content performance.

17. The non-transitory, computer-readable storage medium of claim 15, wherein the NLP profile provides source analytics to predict queries, extract terminology, and drive workflows.

18. The non-transitory, computer-readable storage medium of claim 15, wherein source scanning component provides information to the translatability profile and the NLP profile.

19. The non-transitory, computer-readable storage medium of claim 15, wherein the machine translation level accounts for a risk profile.

20. The non-transitory, computer-readable storage medium of claim 15 further comprising use of a risk score and user experience score with the translatability profile and NLP profile to determine the content performance score.
